(19) United States
(12) Patent Application Publication
(10) Pub. No.: US 2022/0244065 A1
(43) Pub. Date: Aug. 4, 2022

(54) CONTROL DEVICE, CONTROL PROGRAM, AND CONTROL SYSTEM

(71) Applicant: TOYOTA JIDOSHA KABUSHIKI KAISHA, Toyota-shi (JP)

(72) Inventors: Yoshimasa WATANABE, Sunto-gun (JP); Kizuku YAMADA, Susono-shi (JP); Masaki ITO, Toyota-shi (JP); Sakiko YOSHIDA, Mishima-shi (JP); Yuki TAKAHASHI, Susono-shi (JP); Tomonori IMAMURA, Nagoya-shi (JP)

(73) Assignee: TOYOTA JIDOSHA KABUSHIKI KAISHA, Toyota-shi (JP)

(21) Appl. No.: 17/554,351

(22) Filed: Dec. 17, 2021

(30) Foreign Application Priority Data
Jan. 29, 2021 (JP) 2021-013605

(51) Int. Cl. G01C 21/36; G01C 21/34

(52) U.S. Cl. CPC G01C 21/3605; G01C 21/3691; G01C 21/3461

(57) ABSTRACT

The control device according to the present disclosure is a control device that controls a destination of a vehicle. The control device includes a processor that sets, upon acquiring occurrence information of a disaster, when the disaster has occurred at a first destination preset for an electric vehicle to be controlled or in a route to the first destination, a second destination different from the first destination, achieving the same purpose as the first destination, and at which no disaster has occurred, and a route to the second destination and in which no disaster has occurred.

### CROSS-REFERENCE TO RELATED APPLICATION

This application claims priority to Japanese Patent Application No. 2021-013605 filed on Jan. 29, 2021, incorporated herein by reference in its entirety.

### BACKGROUND

### 1. Technical Field

The present disclosure relates to a control device, a control program, and a control system.

### 2. Description of Related Art

Japanese Unexamined Patent Application Publication No. 2013-009534 (JP 2013-009534 A) discloses a technique for safely and quickly charging a battery of a vehicle to be charged, at a moving destination.

### SUMMARY

A power supply vehicle that supplies electric power to another vehicle or the like returns to a return location (destination) to charge itself after power supply. However, when the return location is damaged and a power supply device cannot be used, electric power cannot be supplied to the power supply vehicle at the return location.

The present disclosure has been made in view of the above, and an object of the present disclosure is to provide a control device, a control program, and a control system capable of safely supplying electric power to a power supply target even when the scheduled moving destination of the power supply target is damaged in the event of a disaster.

A control device according to the present disclosure is a control device that controls a destination of a vehicle. The control device includes a processor that sets, upon acquiring occurrence information of a disaster, when the disaster has occurred at a first destination preset for an electric vehicle to be controlled or in a route to the first destination, a second destination different from the first destination, achieving the same purpose as the first destination, and at which no disaster has occurred, and a route to the second destination and in which no disaster has occurred.

Further, a control program according to the present disclosure causes a processor of a control device that controls a destination of a vehicle to set, upon acquiring occurrence information of a disaster, when the disaster has occurred at a first destination preset for the electric vehicle to be controlled or in a route to the first destination, a second destination different from the first destination, achieving the same purpose as the first destination, and at which no disaster has occurred, and a route to the second destination and in which no disaster has occurred.

Further, a control system according to the present disclosure includes: a vehicle; and a control device including a processor that controls a destination of the electric vehicle, and that sets, upon acquiring occurrence information of a disaster, when the disaster has occurred at a first destination preset for the electric vehicle to be controlled or in a route to the first destination, a second destination different from the first destination, achieving the same purpose as the first destination, and at which no disaster has occurred, and a route to the second destination and in which no disaster has occurred.

According to the present disclosure, it is possible to safely supply electric power to the power supply target even when the scheduled moving destination of the power supply target is damaged in the event of a disaster.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing a control system according to an embodiment;

FIG. 2 is a block diagram illustrating configurations of a vehicle management device and a vehicle included in the control system according to the embodiment; and

FIG. 3 is a sequence diagram illustrating a control process executed by the control system according to the embodiment.

### DETAILED DESCRIPTION OF EMBODIMENTS

Hereinafter, an embodiment of the present disclosure will be described below with reference to the drawings. In all the drawings of the following embodiment, the same or corresponding portions are designated by the same reference signs. Further, the present disclosure is not limited to the embodiment described below.

### EMBODIMENT

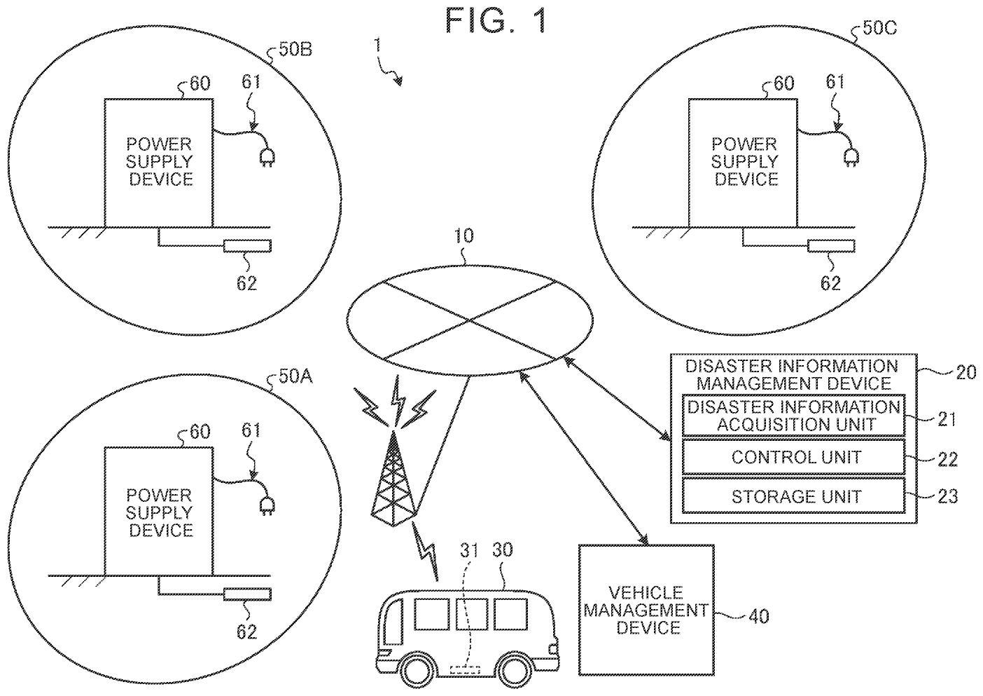

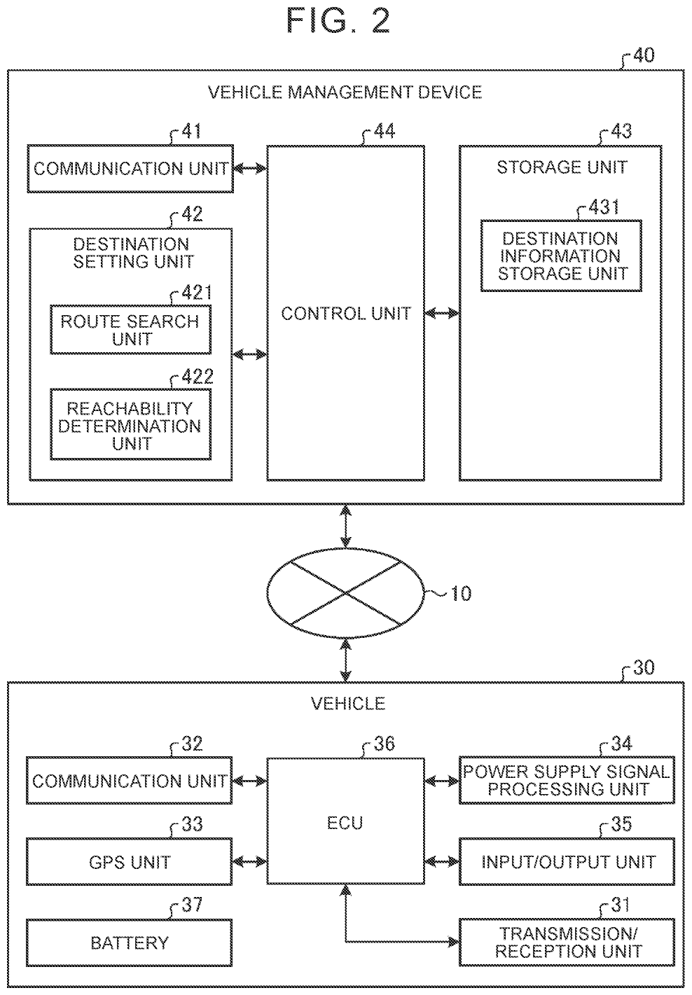

First, a control system according to an embodiment will be described. FIG. 1 is a schematic view showing the control system according to the embodiment. FIG. 2 is a block diagram illustrating a configuration of a vehicle included in the control system according to the embodiment.

A control system 1 includes a disaster information management device 20, a vehicle 30, a vehicle management device 40, and a power supply device 60. In the control system 1 according to the embodiment, the disaster information management device 20, each vehicle 30, and the vehicle management device 40 are connected to each other by a network 10 so as to be communicable with each other. The network 10 is composed of an Internet line network, a mobile phone line network, and the like by which the disaster information management device 20, the vehicle 30, and the vehicle management device 40 are communicable with each other. In the present embodiment, the vehicle 30 is assumed to be an electric vehicle capable of traveling in a hybrid traveling mode or an electric vehicle (EV) traveling mode. The power supply device 60 is provided in each area having different jurisdiction. For example, the power supply device 60 is installed in different areas 50A to 50C, and is controlled by a management center or the like provided in each area and capable of communicating via the network 10.

The disaster information management device 20 transmits the acquired information on power supply control according to the disaster (hereinafter referred to as power supply control information) to the vehicle management device 40 traveling in the corresponding area.

The disaster information management device 20 includes a disaster information acquisition unit 21, a control unit 22, and a storage unit 23. The disaster information management device 20 is configured using one or a plurality of computers including a central processing unit (CPU), a field programmable gate array (FPGA), a read only memory (ROM), a random access memory (RAM), and the like.

The disaster information management device 20 connects to the network 10 and communicates with the vehicle 30 and the vehicle management device 40. The disaster information management device 20 receives information on the disaster (hereinafter also referred to as disaster information) from, for example, a disaster prevention center of a national or local government, and transmits information on control to the vehicle management device 40. Further, the disaster information management device 20 may receive information on the vehicle 30 and the power supply device 60 from the vehicle management device 40 and each area (for example, the areas 50A to 50C).

The disaster information acquisition unit 21 acquires the disaster information of each region acquired from the outside and transmits the disaster information to the vehicle management device 40. The disaster information includes the areas where the disaster has occurred. The disaster information may include the type and scale of the disaster, or may include information on disasters predicted in the future.

The control unit 22 comprehensively controls an operation of each unit of the disaster information management device 20.

The storage unit 23 is configured using a computer-readable recording medium, and various programs and various data are stored in a writable and readable manner. The recording medium includes a storage medium such as an optical disk, a flash memory, and a magnetic disk, and a drive device for these storage media.

Subsequently, the configuration of the vehicle 30 will be described with reference to FIGS. 1 and 2. In the present embodiment, the vehicle 30 is a vehicle capable of supplying electric power to supply electric power to a device including a battery (for example, an electric vehicle). In the vehicle 30, a battery 37 is charged by electric power supplied from a wired power supply unit 61 or a wireless power supply unit 62 managed by the power supply device 60.

The vehicle 30 includes a transmission/reception unit 31, a communication unit 32, a global positioning system (GPS) unit 33, a power supply signal processing unit 34, an input/output unit 35, and an electronic control unit (ECU) 36. The vehicle 30 is provided with the battery 37 that supplies electric power to each unit. The battery 37 is a power storage device and is configured to be rechargeable. Components that control the vehicle 30 are configured using one or a plurality of computers including a CPU, FPGA, ROM, RAM, and the like.

The transmission/reception unit 31 functions as a reception unit that receives a power supply signal from the wireless power supply unit 62. Further, the transmission/reception unit 31 functions as a transmission unit that transmits its own information to the power supply device 60 via an electromagnetic wave. The reception unit and the transmission unit that transmits its own information to the power supply device 60 may be provided separately instead of being integrated.

The communication unit 32 communicates with each device of the outside by wireless communication via the network 10. The communication unit 32 receives information on the disaster and driving support information for supporting the driving of the vehicle 30 from the disaster information management device 20. The driving support information includes road traffic information such as regulations and traffic jams.

The GPS unit 33 receives radio waves from GPS satellites and detects the position of the vehicle 30. The detected position is output to the outside or stored in a storage unit as the position information of the vehicle 30.

The power supply signal processing unit 34 converts the power supply signal received from the power supply device 60 into electric power and supplies the electric power to the battery 38. The power supply signal is a wireless power supply signal received by the transmission/reception unit 31. When wired connection is performed, the supplied electric power is input to the battery 37.

The input/output unit 35 includes a touch panel display, a speaker, a microphone, and the like. The input/output unit 35 is configured to be able to input and output predetermined information such as information on driving support by displaying characters, figures, etc. on the screen of the touch panel display or outputting sound from the speaker in accordance with the control by the ECU 36. Further, the input/output unit 35 is configured such that a user or the like of the vehicle 30 can input predetermined information to the ECU 36 by operating the touch panel display or emitting a voice toward the microphone.

The ECU 36 is composed of an information processing device such as a microcomputer including a CPU, FPGA, ROM, RAM, and the like. The ECU 36 comprehensively controls the electrical operation of each unit of the vehicle 30. The ECU 36 is configured to perform calculation using input data and data and a program stored in advance, and output the calculation result as a control command signal.

The vehicle 30 also includes a storage unit configured by using a computer-readable recording medium. Various programs and various data are stored in this storage unit in a writable and readable manner. The recording medium includes a storage medium such as a hard disk, a semiconductor memory, an optical disk, a flash memory, and a magnetic disk, and a drive device for these storage media. The storage unit stores programs of an operating system (OS) and various applications necessary for the ECU 36 to comprehensively control the operation of each unit of the vehicle 30.

The vehicle 30 is provided with a sensor or the like that detects an object approaching the vehicle 30. The vehicle 30 is further provided with a drive mechanism and an operation mechanism for driving the vehicle 30. Specifically, the vehicle 30 includes a powertrain and drive wheels as the drive mechanism. The powertrain includes a power source that generates a driving force and outputs the generated driving force from an output shaft, and a power transmission mechanism that transmits the driving force output from the power source to the drive wheels. The operation mechanism is composed of a shift lever, an accelerator pedal, and the like. In the present embodiment, the vehicle 30 travels by autonomous driving under the control of the vehicle management device 40. Each unit of the vehicle 30 is driven in accordance with an instruction signal under the control of the ECU 36. Under the control of the vehicle management device 40, the ECU 36 causes the vehicle 30 to travel in the set traveling lane at the set speed.

The vehicle management device 40 is composed of an information processing device such as a microcomputer including a CPU, FPGA, ROM, RAM, and the like. The vehicle management device 40 includes a communication unit 41, a destination setting unit 42, a storage unit 43, and a control unit 44.

The communication unit 41 communicates with each device of the outside by wireless communication via the network 10. The communication unit 41 receives information on the disaster from the disaster information management device 20 and transmits control information for controlling the vehicle 30.

The destination setting unit 42 sets the destination set as the moving destination to which the vehicle 30 will move in the future or sets the destination according to the presence or absence of a disaster in the traveling route to the destination. The destination setting unit 42 includes a route search unit 421 and a reachability determination unit 422.

The storage unit 43 is configured using a computer-readable recording medium, and various programs and various data are stored in a writable and readable manner. The recording medium includes a storage medium such as an optical disk, a flash memory, and a magnetic disk, and a drive device for these storage media. The storage unit 43 has a destination information storage unit 431. The destination information storage unit 431 stores position information of areas and facilities that can be set as destinations, such as representative points of areas where the power supply device 60 is set (for example, the areas 50A to 50C) and the positions of the power supply devices 60.

The control unit 44 comprehensively controls an operation of each unit of the vehicle management device 40.

The power supply device 60 includes the wired power supply unit 61 and the wireless power supply unit 62. The power supply device 60 is configured using one or a plurality of computers including a CPU, FPGA, ROM, RAM, and the like.

The wired power supply unit 61 has a connector for connecting to the vehicle 30. The wired power supply unit 61 transmits a power supply signal to the vehicle 30 with the connector connected to the vehicle 30.

The wireless power supply unit 62 transmits a power supply signal to the vehicle 30 by wirelessly communicating with the transmission/reception unit 31 of the vehicle 30. By transmitting the power supply signal by the wireless power supply unit 62, non-contact charging is performed between the vehicle 30 and the power supply device 60. The transmission/reception unit 31 provided in the vehicle 30 communicates with the power supply device 60 so that a power supply signal is supplied to the vehicle 30.

Further, in the present embodiment, the power supply device 60 has a detection function that detects the vehicle 30 located at the power supply device 60 and a reception function that receives information on the vehicle 30. The detection function and the reception function are configured using, for example, a loop antenna. For example, the detection function transmits a detection signal to the power supply device 60 when the vehicle 30 is detected. Note that, when the vehicle can be detected by a power supply coil or the like, the coil may be used for detection in addition to power supply.

In the present embodiment, non-contact charging is performed between the vehicle 30 and the wireless power supply unit 62. The transmission/reception unit 31 provided in the vehicle 30 communicates with the wireless power supply unit 62 so that a power supply signal is transmitted to the vehicle 30. The transmission/reception unit 31 and the wireless power supply unit 62 are each configured using, for example, a coil, a switching circuit, and a rectifying and smoothing circuit, and transmit and receive the power supply signal by a magnetic field resonance method. With this configuration, the vehicle 30 and the wireless power supply unit 62 communicate with each other in a non-contact state. In the present embodiment, an example in which electric power is supplied and information is transmitted using electromagnetic waves will be described. However, a configuration in which electric power is supplied and information is transmitted using light may be adopted.

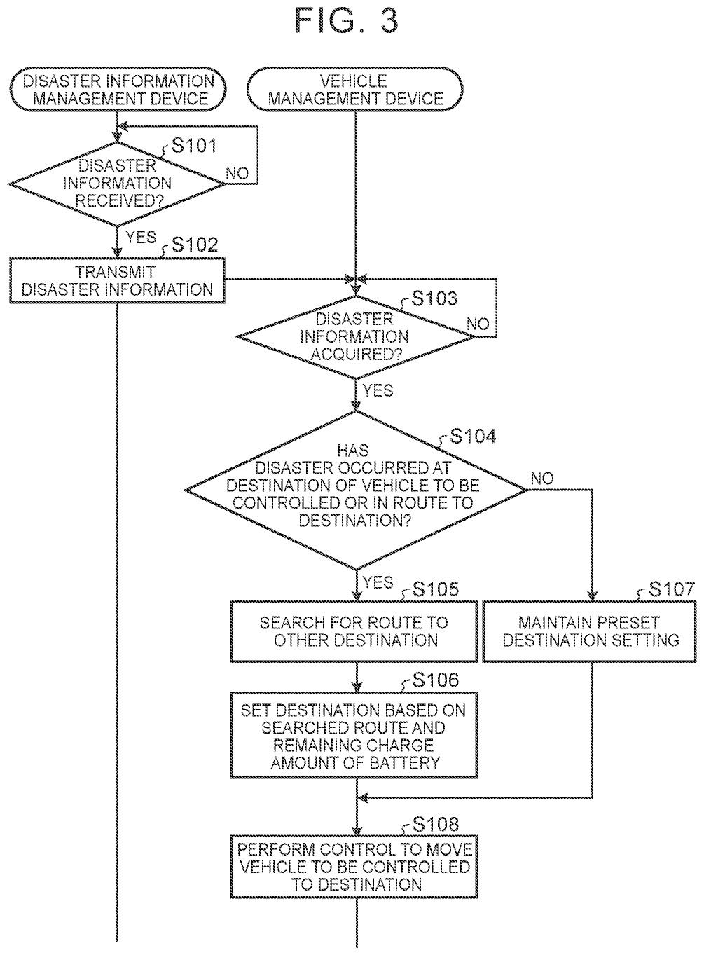

Subsequently, a control process executed by the control system 1 will be described with reference to FIG. 3. FIG. 3 is a sequence diagram illustrating the control process executed by the control system according to the embodiment.

First, the disaster information acquisition unit 21 determines whether the information on the disaster has been received (step S101). When the disaster information acquisition unit 21 determines that the disaster information has not been received (step S101: No), the reception confirmation is repeated. On the other hand, when the disaster information acquisition unit 21 determines that the disaster information has been received (step S101: Yes), the process proceeds to step S102.

In step S102, the disaster information acquisition unit 21 transmits the disaster information to the vehicle management device 40.

In the vehicle management device 40, the communication unit 41 determines whether the disaster information has been acquired (step S103). When the control unit 44 has not acquired the disaster information (step S103: No), the control unit 44 repeats the acquisition confirmation. In response to the above, when the control unit 44 determines that the disaster information has been received (step S103: Yes), the control unit 44 proceeds to step S104.

In step S104, the control unit 44 determines whether a disaster has occurred at the destination of the vehicle 30 to be controlled or in the route to the destination, based on the acquired disaster information. When the control unit 44 determines that a disaster has occurred at the destination or in the route to the destination (step S104: Yes), the control unit 44 proceeds to step S105. On the other hand, when the control unit 44 determines that no disaster has occurred at the destination or in the route to the destination (step S104: No), the control unit 44 proceeds to step S107. Here, the determination that a disaster has occurred is performed by acquiring information, for example, that the power supply device 60 is in an unusable state at the destination, or that the route is in a state where traveling on the road is impossible due to a fallen tree, a sunk road, or the like.

In step S105, the route search unit 421 extracts the destination with reference to the destination information storage unit 431, and searches for the route to the extracted destination. At this time, the route search unit 421 extracts, for example, one or a plurality of destinations that achieves the same purpose as the currently set destination and at which no disaster has occurred, and searches for a route to the destination(s). In the present embodiment, the route search unit 421 extracts a destination capable of achieving the purpose of replenishing electric power for traveling itself and electric power to be supplied to other devices.

The reachability determination unit 422 sets the destination based on the route searched by the route search unit 421 and the remaining charge amount of the battery 37 (step S106). The reachability determination unit 422 determines whether the battery 37 has enough remaining charge amount for reaching the destination from the current location. The reachability determination unit 422 selects a route (destination) that satisfies a preset condition when a plurality of routes are generated and two or more routes thereof are reachable. The reachability determination unit 422 selects, for example, the destination having the shortest route length. As a condition, a route having the smallest height difference, a route having the smallest number of traffic lights, and the like can also be set.

Here, the power supply device 60 is installed at the destination set in the present embodiment. The “plurality of routes” may be a plurality of routes set for the same destination, may be each route to a different destination, or may include one or a plurality of routes set for a plurality of destinations.

In step S107, the destination setting unit 42 maintains the preset destination setting. At this time, the route search unit 421 searches for a route to the destination and sets the route. At this time, the route search unit 421 searches for a route in which no disaster has occurred. Further, the reachability determination unit 422 sets the destination based on the searched route and the remaining charge amount of the battery 37. In the present embodiment, electric power is supplied to other devices while leaving enough remaining charge amount for reaching a preset destination.

After that, the vehicle management device 40 performs control to move the vehicle 30 to the destination along the route set in step S106 or S107 (step S108).

In the embodiment described above, when a disaster has occurred at the destination of the vehicle 30 that supplies electric power to other devices or in the route to the destination, the destination is set to another destination at which no disaster has occurred and in which no disaster has occurred in the route to the other destination. According to the present embodiment, when a disaster occurs, the vehicle 30 is moved to the destination where the power supply device 60 is set through a route without a disaster. Therefore, even when the destination of the power supply target is damaged, it is possible to safely supply electric power to the power supply target.

Recording Medium

According to the embodiment, a program capable of executing a processing method by the power supply control system can be recorded in the recording medium that is readable by a computer or other machines or devices (hereinafter referred to as “computer or the like”). The computer or the like functions as the control units of each device of a power supply control system as the computer or the like is caused to read the program stored in the recording medium and execute the program. Here, the recording medium that is readable by the computer or the like means a non-transitory recording medium that can accumulate information such as data or programs through electrical, magnetic, optical, mechanical, or chemical action and read the information from the computer or the like. Examples of the recording medium removable from the computer or the like among the recording media above include a flexible disk, a magneto-optical disk, a compact disc read-only memory (CD-ROM), a compact disc rewritable (CD-R/W), a digital versatile disc (DVD), a Blu-ray disc (BD), a digital audio tape (DAT), a magnetic tape, and a memory card such as a flash memory. Examples of the recording medium fixed to the computer or the like include a hard disk and a read-only memory (ROM). Further, a solid state drive (SSD) can be used as the recording medium removable from the computer or the like or as the recording medium fixed to the computer or the like.

### Other Embodiment

In the control system according to the embodiment, the “unit” can be read as a “circuit” or the like. For example, the communication unit can be read as a communication circuit.

The program to be executed by each device of the control system according to the embodiment may be configured to be stored in a computer connected to a network such as the Internet and provided through downloading via the network.

Further, in the embodiment, the example in which the vehicle 30 is driven under the control of the vehicle management device 40 has been described, but the case where the vehicle 30 is driven by the operation of the driver can also be applied. At this time, the vehicle management device 40 transmits information (navigation information) on the destination and its route to the vehicle 30. The driver of the vehicle 30 drives the vehicle 30 in accordance with the acquired information.

Further, in the embodiment, the example in which the vehicle 30 is an electric vehicle provided with the battery 37 and driven by electric energy, and is an supply vehicle that supplies electric power (energy) to other vehicles and rechargeable devices (for example, lighting, radio, etc.) has been described. The vehicle 30 is not limited to this, and, for example, a gasoline vehicle that is driven using gasoline as energy and that supplies gasoline to other vehicles, a vehicle that drives the vehicle by energy other than electricity and gasoline, a vehicle that carries supplies to be supplied at the destination, and the like can also be applied.

Further effects and modifications can be easily derived by those skilled in the art. The broader aspects of the present disclosure are not limited to the particular details and representative embodiments shown and described above. Accordingly, various modifications may be made without departing from the scope of the general inventive concept defined by the appended claims and their equivalents.

What is claimed is:

1. A control device that controls a destination of a vehicle, the control device comprising a processor that sets, upon acquiring occurrence information of a disaster, when the disaster has occurred at a first destination preset for the vehicle to be controlled or in a route to the first destination, a second destination different from the first destination, achieving the same purpose as the first destination, and at which no disaster has occurred, and a route to the second destination and in which no disaster has occurred.

2. The control device according to claim 1, wherein the first destination and the second destination are destinations for replenishing energy to be supplied by the vehicle to other devices and/or energy for the vehicle to travel.

3. The control device according to claim 2, wherein the processor determines whether a remaining amount of the energy is a remaining amount that allows reaching the second destination from a current location.

4. The control device according to claim 1, wherein when the processor extracts a plurality of destinations as the second destination, the processor selects a destination satisfying a preset condition as the second destination.

5. The control device according to claim 4, wherein the processor sets a destination with a shortest route length as the second destination.

6. The control device according to claim 1, wherein a power supply device for supplying electric power to the vehicle is installed at the first destination and the second destination.

7. A control program that causes a processor of a control device that controls a destination of a vehicle to set, upon acquiring occurrence information of a disaster, when the disaster has occurred at a first destination preset for the vehicle to be controlled or in a route to the first destination, a second destination different from the first destination, achieving the same purpose as the first destination, and at which no disaster has occurred, and a route to the second destination and in which no disaster has occurred.

8. The control program according to claim 7, wherein the first destination and the second destination are destinations for replenishing energy to be supplied by the vehicle to other devices and/or energy for the vehicle to travel.

9. The control program according to claim 8, wherein the processor determines whether a remaining amount of the energy is a remaining amount that allows reaching the second destination from a current location.

10. The control program according to claim 7, wherein when the processor extracts a plurality of destinations as the second destination, the processor selects a destination satisfying a preset condition as the second destination.

11. The control program according to claim 10, wherein the processor sets a destination with a shortest route length as the second destination.

12. The control program according to claim 7, wherein a power supply device for supplying electric power to the vehicle is installed at the first destination and the second destination.

13. A control system comprising:
a vehicle; and
a control device including a processor that controls a destination of the vehicle, and that sets, upon acquiring occurrence information of a disaster, when the disaster has occurred at a first destination preset for the vehicle to be controlled or in a route to the first destination, a second destination different from the first destination, achieving the same purpose as the first destination, and at which no disaster has occurred, and a route to the second destination and in which no disaster has occurred.

14. The control system according to claim 13, wherein the first destination and the second destination are destinations for replenishing energy to be supplied by the vehicle to other devices and/or energy for the vehicle to travel.

15. The control system according to claim 14, wherein the processor determines whether a remaining amount of the energy is a remaining amount that allows reaching the second destination from a current location.

16. The control system according to claim 13, wherein when the processor extracts a plurality of destinations as the second destination, the processor selects a destination satisfying a preset condition as the second destination.

17. The control system according to claim 13, wherein the processor sets a destination with a shortest route length as the second destination.

18. The control system according to claim 17, wherein a power supply device for supplying electric power to the vehicle is installed at the first destination and the second destination.

19. The control system according to claim 13, wherein the processor controls traveling of the vehicle.

20. The control system according to claim 19, wherein the processor drives the vehicle to move the vehicle to the first destination or the second destination.
